(19) United States
(12) Patent Application Publication
(10) Pub. No.: US 2019/0318441 A1
(43) Pub. Date: Oct. 17, 2019

(54) INDIRECT LUGGAGE WEIGHT IDENTIFICATION

(71) Applicant: International Business Machines Corporation, Armonk, NY (US)

(72) Inventors: Deepak Gupta, Indirapuram (IN); Saraca Raina Nambiar, Delhi (IN); Alok Sharma, Gaziabad (IN); Namita Gupta, Indirapuram (IN)

(21) Appl. No.: 15/952,276

(22) Filed: Apr. 13, 2018

(51) Int. Cl. G06Q 50/28; G06Q 10/06; G06N 5/04

(52) U.S. Cl. CPC G06Q 50/28; G06N 5/04; G06Q 10/0633

(57) ABSTRACT

Embodiments of the present invention provides methods, computer program products, and a system for indirectly weighing a load. Embodiments of the present invention can be used to collect recordings of a user interacting with a load, analyzing the recordings based on baseline measurements and a variety of measurement techniques, and predicting a weight of the load based on the analysis without directly weighing the load. Embodiments of the present invention can be used to issue a notification to a user based on the weight of the load to inform the user the load is overweight, to allow the user to print luggage tickets, and to allow the user to pay for baggage fees.

### BACKGROUND

The present invention relates generally to the field of weights and measurements, and more particularly to predicting weights of loads.

Airports and railway stations are fast moving towards digitization of processing passengers to the benefit of passenger experience and to the bottom line of the mass transit service company while still maintaining effective security measures. These methods include online ticket purchasing, self check-in queues, pre-approval of passengers by a security administration, and group boarding methods for passengers.

One step in processing passengers for mass transit is baggage collection. This can include declaring the number of baggage associated with the passenger, weighing the baggage, attaching a tracking tag to the baggage for proper delivery, and inspecting the baggage for security threats. After a passenger checks in at a transit station, airline staff assist the passenger with weighting passenger baggage to determine whether the baggage is within a predetermined weight limit. If a baggage is overweight, the airline staff may charge the passenger an overweight baggage fee. In particular with airline transit, baggage weights are an important factor for an airline in ensuring that cargo of an aircraft is properly balanced as improper cargo balance can lead to disastrous results in aircraft maneuvering.

### SUMMARY

Embodiments of the present invention disclose a method, a computer program product, and a system for indirectly weighing luggage. In one embodiment of the present invention, a method is provided comprising: analyzing recordings of a user interacting with a load based on a baseline measurement and a set of measurement techniques; predicting a weight of the load based on the analyzed recordings of the user interacting with the load; and generating a recommendation that includes a series of actions and notifications to be displayed on a user interface based on the predicted weight.

### BRIEF DESCRIPTION OF THE DRAWINGS

FIG. 1 is a functional block diagram illustrating a weight collection environment, in accordance with an embodiment of the present invention;

FIG. 2 is a flowchart depicting operational steps of a weight program for predicting a weight of a load associated with a user, in accordance with an embodiment of the present invention;

FIG. 3 is a flowchart depicting operational steps of predicting a weight of a load associated with a user based on the analyzed recordings, in accordance with an embodiment of the present invention;

FIG. 4A is an example environment diagram illustrating a home environment for a weight program, in accordance with an embodiment of the present invention;

FIG. 4B is a table listing the techniques, measured values, and corresponded weights for a recording of a user interacting with a load;

FIG. 4C is an example environment diagram illustrating a transit environment for a weight program, in accordance with an embodiment of the present invention;

FIG. 4D is a table listing the techniques, measured values, and corresponded weights for a recording of a user interacting with a load; and

FIG. 5 depicts a block diagram of components of the computing systems of FIG. 1, in accordance with an embodiment of the present invention.

### DETAILED DESCRIPTION

Embodiments of the present invention recognize that overweight passenger luggage can hinder swift passenger processing when checking in luggage. For example, a passenger may be unaware that the luggage of the passenger is overweight, so when the time comes for an airline staff to weigh the luggage, the airline staff and passenger both discover the luggage is overweight, and then a decision must be made by the passenger to either pay an overweight fee or discard elements stored in the luggage in order to bring the luggage back under weight. This process of discovery can lead to considerable time delays when this occurs with multiple passengers throughout the day, thus creating an additional bottleneck in processing thousands of passengers each day. Airlines can expedite this process by allocating additional staff to process passengers, however, this comes at a cost to the airline.

Embodiments of the present invention provide solutions for improving check-in and weight screening systems. Specifically, embodiments of the present invention provide solutions for improved weight detection systems. For example, embodiments of the present invention provide a weight detection system comprising one or more sensors, cameras, and display screens that use facial recognition and posture analysis to identify overweight luggage, generate a recommendation to an administrator, and send the recommendation to the administrator and the owner of the overweight luggage. In some embodiments, the recommendation can be a request for payment for the overweight luggage and/or a transmission of a set of instructions to generate one or more baggage tags for baggage check-in based on the quantity of baggage and a predicted weight of the baggage associated with a user. In certain embodiments, the weight detection system can comprise multiple components in a single electronic device. As described in greater detail later in this specification, embodiments of the present invention provide the capability of indirectly weighing luggage based upon monitored user behavior in handling the luggage. The embodiments of the present invention reduce waiting times for passengers for processing, reduce efforts of airline staff and crew, minimize the possibility of extra cargo weight, and assist in detecting suspicious elements of passengers who are traveling with overweight luggage. Implementation of embodiments of the invention may take a variety of forms, and exemplary implementation details are discussed subsequently with reference to the Figures.

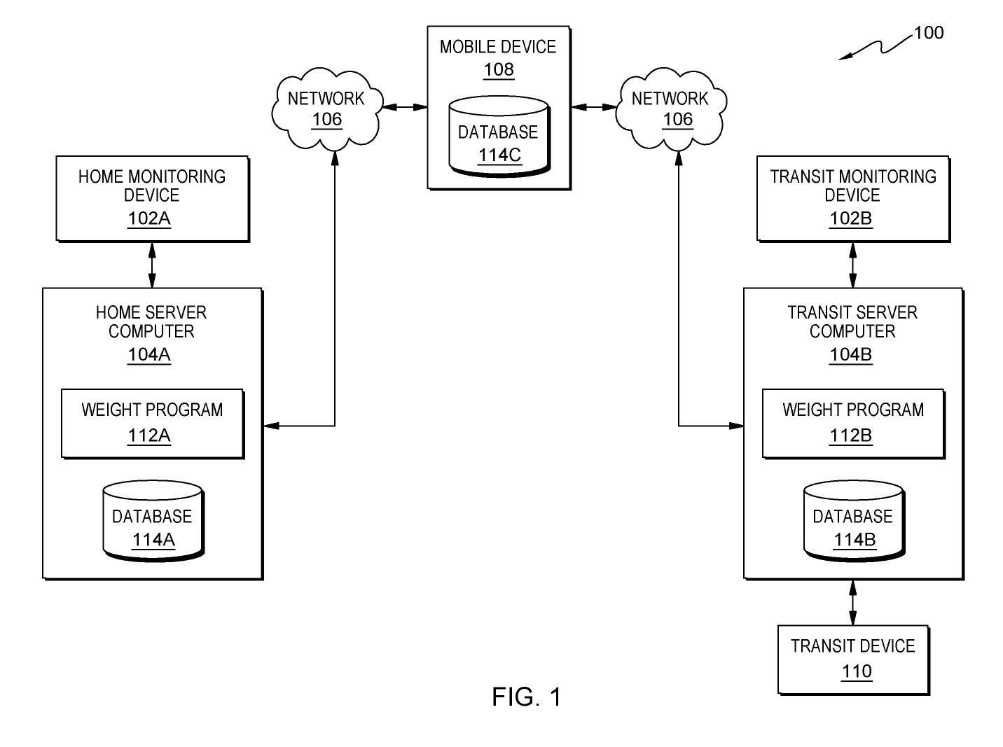

FIG. 1 is a functional block diagram illustrating a weight collection environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

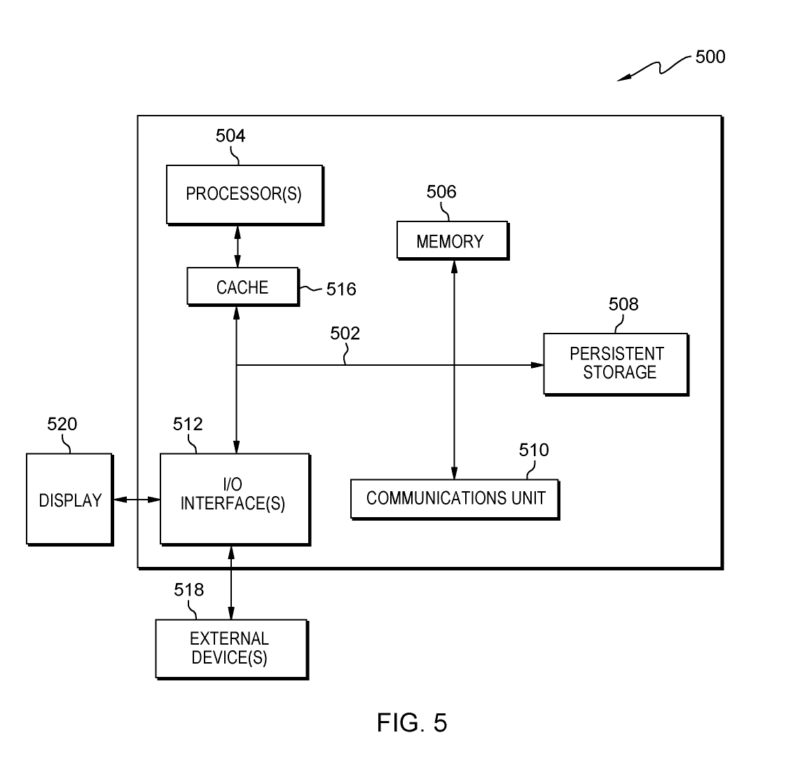

Weight collection environment 100 includes home monitoring device 102A, transit monitoring device 102B, home server computer 104A, transit server computer 104B, mobile device 108, and transit device 110, all interconnected over network 106. Home server computer 104A, transit server computer 104B, and mobile device 108 can each be a standalone computing device, a management server, a webserver, a mobile computing device, or any other electronic device or computing system capable of receiving, sending, and processing data. In other embodiments, home server computer 104A, transit server computer 104B, and mobile device 108 can each represent a server computing system utilizing multiple computers as a server system, such as in a cloud computing environment. In another embodiment, home server computer 104A, transit server computer 104B, and mobile device 108 can each be a laptop computer, a tablet computer, a netbook computer, a personal computer (PC), a desktop computer, a personal digital assistant (PDA), a smart phone, or any programmable electronic device capable of communicating with various components and other computing devices (not shown) within weight collection environment 100 via network 106. In another embodiment, home server computer 104A, transit server computer 104B, and mobile device 108 each represent a computing system utilizing clustered computers and components (e.g., database server computers, application server computers, etc.) that act as a single pool of seamless resources when accessed within weight collection environment 100. Home server computer 104A, transit server computer 104B, and mobile device 108 may include internal and external hardware components capable of executing machine-readable program instructions, as depicted and described in further detail with respect to FIG. 5.

Home server computer 104A and transit server computer 104B include a weight program (i.e., weight program 112A and weight program 112B respectively), and a database (i.e., database 114A and database 114B respectively). In general, weight program 112A and 112B is a program capable of collecting video recordings of posture and facial expressions of a user while interacting with various loads, collecting audio recordings of a user while interacting with various loads, collecting video recordings of luggage being handled by the user, predicting a weight of the luggage based on analysis of the audio and video recordings, and generating a recommendation, wherein the recommendation is created for display on a user device that includes a series of actions and notifications to be displayed on a user interface based on the predicted weight.

As used herein, “baggage”, “luggage”, and “load” can be used interchangeably. As used herein, a “user” can be a person or device that utilizes weight program 112, wherein the utilization can be weight program 112 recording the user interacting with a load, and/or can be weight program 112 generating a recommendation for a user based on a predicted weight. In some embodiments, a user interacts with a load and receives a recommendation from weight program 112 based on the interaction of the user with the load. In another embodiment, a first user interacts with a load, and a second user receives a recommendation from weight program 112 based on the interactions of the first user with the load. In an alternate embodiment, a second user interacts with a load associated with a first user, and the second user receives a recommendation from weight program 112 based on the interaction of the second user with the load. In an even further embodiment, a first user can be a device that interacts with a load, and a second user can be a person or a second device that receives a recommendation from weight program 112 based on the interaction of the first user with the load. For example, a first user can be a truck operated by a driverless computer system that is receiving a load, and the second user is a person or a computing device that receives a weight associated with the load predicted by weight program 112, which then the second user can subsequently inform the driverless computer system that the truck is at a target weight capacity based on the predicted weight of the load.

In one embodiment, home server computer 104A, and subsequently weight program 112A, serves the role of collecting video recordings of posture and facial expressions of a user, and collecting video recordings of luggage being handled by the user, all while being recorded at a home of the user by home monitoring device 102A. Weight program 112A stores the collected video recordings on database 114A. As used herein, video recordings of posture and facial expressions of a user while interacting with various loads, audio recordings of the user while interacting with various loads, as well as video recordings of the luggage, are jointly referred to as “recordings”.

Similarly, transit server computer 104B, and subsequently weight program 112B, serve the role of collecting video recordings of posture and facial expressions of the user, and collecting video recording of luggage being handled by the user, all while being recorded at the transit station by transit monitoring device 102B. Weight program 112B collects recordings of the user and the luggage of the user stored on mobile device 108 via network 106. Weight program 112B collects video recordings of posture and facial expressions of transit staff who handle the luggage of the user. Weight program 112B stores the collected video recordings on database 114B. Furthermore, weight program 112B serves the role of analyzing the collected recordings in predicting the weight of the luggage.

In an alternative embodiment, weight program 112 can predict a weight of a load carried by a vehicle based on recorded deviations of a structure of the vehicle (e.g. deviations in a suspension or wheel system of the vehicle) and a baseline measurement of the vehicle while under no loads. For example, weight program 112 records a baseline measurement of a truck that is carrying no load. The truck receives a load, which subsequently causes the tires and suspension system to compress due to a weight of the load. Weight program 112 can predict the weight of the load carried by the truck based on a recording of the compressed tires of the truck, a recording of the compressed suspension system of the truck, and the baseline measurement of the truck.

In another alternative embodiment, weight program 112 can predict a weight of a load carried by a vehicle based on recorded deviations of an environment in contact with the vehicle and a baseline measurement of the environment in contact with the vehicle while under no loads. For example, weight program 112 records a baseline measurement of a water level of the ship carrying no load while floating in a body of water. The ship receives a load, which subsequently causes the ship to lower further into the body of water due to a weight of the load. Weight program 112 can predict the weight of the load carried by the ship based on a recording of the lowered water level of the ship and the baseline measurement of the water level of the ship.

Mobile device 108 includes database 114C. Mobile device 108 serves as a surrogate in transferring recordings from a database of a home server computer (i.e., database 114A) to a database of a transit server computer (i.e., database 114B) by uploading recordings stored on database 114A onto database 114C. In some embodiments, weight program 112A continuously uploads recordings stored on database 114A to database 114C via network 106. In one embodiment, when a user carrying mobile device 108 enters a transit station containing transit server computer 104B, weight program 112B instructs transit server computer 104B to upload recordings stored on database 114C onto database 114B. In an alternative embodiment, mobile device may not necessarily store recordings on database 114C, but instead serves as a trigger for transit server computer 104B to upload recordings stored on database 114A onto database 114B via network 106 when weight program 112B detects mobile device 108 is within a predetermined range of the transit station.

Database 114A, database 114B, and database 114C are repositories for storing video recordings for analysis by weight program 112B. Database 114A, database 114B, and database 114C can be implemented with any type of storage device capable of storing data and configuration files that can be accessed and utilized by home server computer 104A, transit server computer 104B, and mobile device 108, such as a database server, a hard disk drive, or a flash memory. Database 114B contains a statistical distribution of user-load interactions corresponding to a profile of a user, wherein the statistical distribution of user-load interactions contains statistical relationships between a value determined by a measurement technique and a load being experienced by the user. A profile of a user includes, but is not limited to, a sex of the user, an age of the user, height, weight and current health status of the user. For example, a user exuding 50% of their effort corresponds to a 50 lbs. load based on a profile of the user.

Home monitoring device 102A and transit monitoring device 102B are cameras capable of recording video footage that is stored by home server computer 104A and transit server computer 104B respectively. For example, a home monitoring device can be a home web camera connected to a personal computer of a user (i.e., home server computer 104A). Likewise, a transit monitoring device can be security surveillance camera located near a check-in terminal at an airport, wherein the security surveillance camera is connected to the airport computer system used by airline and security staff (i.e., transit server computer 104B).

Transit device 110 are computing devices used by transit staff and security staff that interacts with and displays information transmitted from weight program 112B. For example, weight program 112B can generate a display for transit device 110. The display can be a generated security alert and/or one or more functional screens to enable a user of transit device 110 to generate one or more baggage tags and/or request payment for one or more baggage tags. Transit device 110 can be a laptop computer, a tablet computer, a netbook computer, a personal computer (PC), a desktop computer, a personal digital assistant (PDA), a smart phone, or any programmable electronic device capable of communicating with various components and other computing devices (not shown) within weight collection environment 100 via network 106.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among home server computer 104A, transit server computer 104B, and other computing devices (not shown) within weight collection environment 100.

For illustrative purposes, the following discussion is made with respect to weight program 112A and weight program 112B hosted on home server computer 104A and transit server computer 104 respectively. However, it should be understood that weight program 112A and weight program 112B can be on a single device, a combination of devices, and/or on one or more other components of weight collection environment 100.

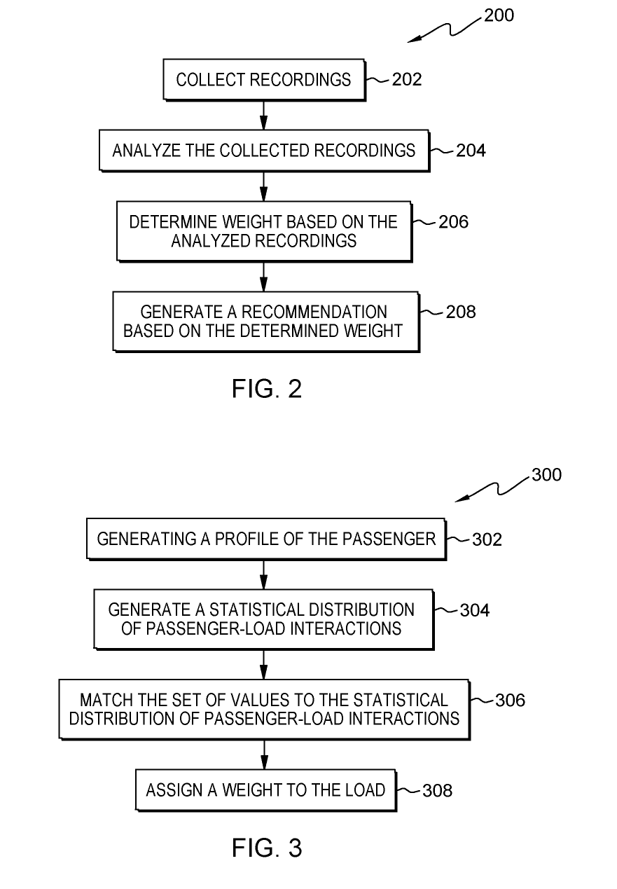

FIG. 2 is a flowchart 200 depicting operational steps of a weight program for predicting a weight of a load associated with a user, in accordance with an embodiment of the present invention. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

In step 202, weight program 112 collects recordings. In this embodiment, weight program 112A collects recordings by transmitting a set of instructions to home server computer 104A to begin recording audio and video transmissions from home monitoring device 102A onto database 114A. In this embodiment, weight program 112A collects recordings of a passenger interacting with various loads, wherein recordings of the passenger interaction with various loads includes, but is not limited to, the posture and facial expressions of a passenger as well as audible sounds produced by the passenger while: a) the passenger is carrying a load on the shoulder of the passenger (e.g., a satchel or messenger bag), b) the passenger is carrying a load on the back of the passenger (e.g., a rucksack or backpack), c) the passenger is carrying a load in the hands of the passenger (e.g., an attaché case or grocery bags), d) the passenger is moving cumbersome objects around the home of the passenger (e.g., chairs, tables, couches, etc.). For example, a passenger prepares for a trip using a mass transit service, and while the passenger is packing belongings into a piece of luggage, the passenger and the piece of luggage is monitored by a camera (i.e., home monitoring device 102A) that connected a personal computer of the passenger (i.e., home server computer 104A). As the passenger packs items into the luggage and subsequently leaves the home of the passenger with the luggage, weight program 112 instructs the personal computer of the passenger to store audio and video recordings of the passenger onto a storage drive of the personal computer (i.e., database 114A).

In alternate embodiment, weight program 112A collects recordings by transmitting a set of instructions to home server computer 104A to begin recording audio and video transmissions from home monitoring device 102A onto database 114A, wherein home server computer 104A and home monitoring device 102A operate on a single device. For example, a passenger prepares for a trip using a mass transit service, and while the passenger is packing belongings into a piece of luggage, the passenger and the piece of luggage is monitored with a mobile device containing the elements of home monitoring device 102A and home server computer 104A (e.g., a smart phone with a built-in camera and microphone).

In a further embodiment, as weight program 112A collects recordings onto database 114A, weight program also collects recordings by transmitting a set of instructs to home server computer 104A to continuously upload the recordings onto database 114C of mobile device 108. In continuing from the previous example, as the personal computer of the passenger stores recordings onto the storage drive, weight program 112A instructs the personal computer and a mobile phone of the passenger (i.e., mobile device 108) to continuously upload (i.e. synchronize) such that the storage drive of the mobile device (i.e., database 114C) contains a copy of the recordings collected on the storage drive of the personal computer.

In an even further embodiment, when the passenger enters within a predetermined range of the transit station, weight program 112B detects that the passenger has entered within the predetermined range. Weight program 112B then collects recordings by instructing transit server computer 104B and mobile device 108 to download recordings stored on database 114C onto database 114B. In continuing from the previous example, as the passenger enters the transit station, weight program 112B detects that the passenger has entered the transit station by receiving a signal from the mobile phone of the passenger (i.e., mobile device 108) informing that the mobile phone has detected a local wi-fi network associated with transit server computer 104B. Upon detecting the entrance of the passenger, weight program 112B instructs transit server computer 104B and the mobile phone of the passenger to download the recordings stored on database 114C onto database 114B.

In another embodiment, weight program 112A collects recordings by continuously uploading video recordings of a passenger interacting with a load to database 114B via network 106. For example, a passenger interacts with a load while being recorded by home monitoring device 102A. Weight program 112A continuously uploads the recording via network 106 to transit server computer 104B and is subsequently stored on database 114B.

In another embodiment, weight program 112B collects recordings by instructing transit server computer 104B to store audio and video transmissions from transit monitoring device 102B onto database 114B. In this embodiment, weight program 112B collects recordings of the passenger and transit staff interacting with various loads, wherein recordings of the passenger and the transit staff interaction with various loads includes, but is not limited to, the posture and facial expressions of the passenger and transit staff as well as audible sounds produced by the passenger and the transit staff while: a) the passenger or the transit staff is carrying a load on the shoulder of the passenger or the transit staff respectively, b) the passenger or the transit staff is carrying a load on the back of the passenger or transit staff respectively, c) the passenger or the transit staff is carrying a load in the hands of the passenger or transit staff respectively, and while d) the passenger or the transit staff is moving cumbersome objects around the transit station.

In step 204, weight program 112B analyzes the collected recordings. In this embodiment, weight program 112B analyzes the collected recordings by assigning a set of values to a recording of a passenger interacting with a load among the collected recordings, wherein a value among the set of values is based, at least in part, on a baseline measurement of a passenger and a measurement technique. Weight program 112B later uses the set of values assigned to a recording to predict a weight of the load. A measurement technique is a method of measuring a characteristic of a passenger. A characteristic of the passenger includes, but is not limited to, posture, facial demeanor, and audible sounds produced by the passenger. A measurement technique with regards to a posture of a passenger include, but is not limited to, static measurements, dynamic measurements, and defect measurements. Static measurements include posture measurements while the passenger is sitting, posture measurements while the passenger is standing, posture changes as a result of growth, stabilization mechanisms, Alexander technique, and Perry Technique. Dynamic measurements include measurements of dynamic postures (i.e., postures while the passenger is in motion), gait, and applied fluid dynamics (i.e., measurements of the motion of non-rigid components of the body of the passenger, such as muscles and fats). Defect measurements include measurements of the use of bipedalism by the passenger, a body and balance defects, etiology of postural faults, and basic physiologic reactions to postural faults.

In another embodiment, a measurement technique is a method of measuring a characteristic of a load, wherein a characteristic of a load includes, but is not limited to, material composition of the load (e.g., a suitcase with a fabric or hard plastic body) and volume of the load (e.g., a suitcase with 20 liters of volume)

A measurement technique with regards to a facial demeanor include, but is not limited to, structural analysis of the face of the passenger (e.g., a degree of stress and strain of a face of a passenger as a result of contraction of facial muscles of the passenger). A measurement technique with regards to audible sounds produced by the passenger include decibel measurements of the sound produced by the passenger.

A baseline measurement of a passenger is a measurement based on a measurement technique applied to a recording of the passenger, wherein the recording of the passenger is a recording of the passenger experiencing no loads. Weight program 112B assigns a value to a recording of the passenger, wherein the value is a relative measure of deviation from a baseline measurement of the passenger. For example, weight program 112B records a passenger experiencing no loads. Weight program 112B assigns the recordings of the passenger experiencing no loads as a baseline measurement of the passenger with respect to posture, facial demeanor, and audible sounds, and subsequently assigns the value of zero for each respective measurement technique. Weight program 112B then records the passenger picking up a first suitcase (i.e., a load). Weight program 112B analyzes the recording by measuring deviations from the baseline measurement of the passenger for each measurement technique corresponding to a characteristic of the passenger and assigns the recording a value of 5, wherein the value is within a numerical scale ranging from 0 to 10 where a lower number (e.g., 1) indicates a lower deviation from the baseline measurement, and a higher number (e.g., 9) indicates a higher deviation from the baseline measurement. Weight program 112B then records the passenger picking up a second suitcase that is twice as massive as the first suitcase. Weight program 112B analyzes the recording by measuring that the deviations from the baseline measurements are now twice as much as when the passenger picked up the first suitcase, subsequently assigning the recording of the passenger picking up the second suitcase a value of 10.

In another embodiment, weight program 112B analyzes the collected recordings by using facial recognition software in associating a passenger with the collected recordings based on a baseline measurement of a passenger. In this embodiment, weight program 112A collects a recording to be used as a baseline measurement (i.e., a recording of the passenger experiencing no loads), and generates a profile for the passenger associated with the recording. The profile includes, but is not limited to, a sex of the passenger, an age of the passenger, height, weight and current health status of the passenger. Weight program 112A receives inputs from the passenger that details the profile of the passenger. For example, weight program 112A generates a profile of a passenger upon collecting a recording of the passenger experiencing no loads. Weight program 112A receives inputs from the passenger detailing the sex, age, height, weight, and current health status of the passenger and stores the inputs as part of the profile of the passenger. After weight program 112B has collected recordings of the passenger, weight program 112B analyzes the recordings by using facial recognition software to identify the passenger, and subsequently associates the recordings of the passenger with the profile of the passenger based on the identified passenger in the recordings.

In some embodiments, weight program 112 can analyze the collected recordings at various stages of a passenger transitioning from a home of the passenger, to a transit station that the passenger arrives for mass transit transportation, or in a combination thereof. In a first example, weight program 112A analyzes the collected recordings collected from home monitoring device 102A. Responsive to analyzing the collected recordings, weight program 112A can then proceed to step 206 in predicting a weight based on the analyzed recordings, and then proceed to step 208 in generating a recommendation for the passenger based on the predicted weight. For example, a passenger has home server computer 104A and home monitoring device 102A collect and analyze the collected recordings from a home of the passenger interacting with a load. In response to the analyzed recordings obtained at the home of the passenger, weight program 112A predicts the weight based on the analyzed recordings, and then generates a recommendation to the passenger. As described above, the recommendation can a series of actions to be taken by the user and/or one or more notifications to be displayed on an electronic device. In some instances, the recommendation includes a confirmation of predicted weight and a recommended course of action in accordance with the predicted weight. For example, in instances where the predicted weight is within a weight limit specified by a transit authority, weight program 112A can confirm the predicted weight, inform the transit authority of the predicted weight, and complete a check-in process for the user (e.g., provide the user with an opportunity to pay for the checked-in bag, etc.)

In a second example, weight program 112B only analyzes the collected recordings collected from transit monitoring device 102B. Responsive to analyzing the collected recordings, weight program 112B can then proceed to step 206 in predicting a weight of a load based on the analyzed recordings, and then proceed to step 208 in generating a recommendation based on the predicted weight of the load to transit device 110 for a transit staff. For example, a passenger carrying a load arrives at a transit station, and weight program 112B transmits a set of instructions to transit monitoring device 102B to collect recordings of the passenger interacting with the load. Weight program 112B analyzes the collected recordings, then proceeds to step 206 in predicting a weight of the load based on the analyzed recordings, and proceeds to step 208 in generating a recommendation based on the predicted weight of the load to a computer terminal associated with a transit staff (i.e., transit device 110), wherein the recommendation informs the transit staff that the load associated with the passenger was predicted to be overweight.

In a third example, weight program 112B analyzes the collected recordings collected from home monitoring device 102A and transit monitoring device 102B simultaneously. For example, weight program 112B has collected recordings of a passenger captured by home monitoring device 102A stored on database 114B (e.g., the transit station database). At a later time, weight program 112B collects recordings of the passenger transporting a load captured by transit monitoring device 102B and subsequently stores the recording on database 114B. Upon collecting the recording of the passenger by transit monitoring device 102B, weight program 112B analyzes the collected recordings captured by home monitoring device 102A and the collected recordings captured by transit monitoring device 102B.

In a fourth example, weight program 112A analyzes the collected recordings collected from home monitoring device 102A, predicts a weight of the load, then generates a recommendation for the passenger. Then, once the passenger arrives at a transit station, weight program 112B analyzes the collected recordings collected from transit monitoring device 102B second, predicts a weight based on the analyzed recordings captured by transit monitoring device 102B, compares the predicted weight of the load from the analyzed recordings captured by transit monitoring device 102B to the predicted weight of the load from the analyzed recordings from home monitoring device 102A, and then generates a recommendation noting any changes and/or discrepancies between the two predicted weights of the load. For example, a passenger approaches a transit station but has not yet been detected by transit monitoring device 102B. Weight program 112B collects recordings captured by home monitoring device 102A prior to detecting the passenger on transit monitoring device 102B (i.e., the passenger has not yet been detected by a security camera at the transit station). Weight program 112B then analyzes the collected recordings collected from home monitoring device 102A prior to collecting recordings of the passenger captured by transit monitoring device 102B. Then, once the passenger is recorded by weight program 112B via transit monitoring device 102B, weight program 112B analyzes the collected recordings collected by transit monitoring device.

In step 206, weight program 112B predicts a weight based on the analyzed recordings. In this embodiment, weight program 112B predicts a weight of a load moved by a passenger by acquiring the profile of the passenger, acquiring a statistical distribution of user-load interactions based on the profile of the passenger, matching the set of values corresponding to the collected recordings to the statistical distribution of user-load interactions, and assigning a weight to the load based on the matched set of values to the statistical distribution of user-load interactions as described in greater detail with regard to FIG. 3, flowchart 300.

In step 208, weight program 112B generates a recommendation based on the predicted weight. In this embodiment, weight program 112B generates a recommendation based on the predicted weight of a luggage by transmitting a report for display on transit device 110, wherein the display of the report includes an interface that specifies a screen for, at least, passenger identification, luggage identification, the predicted weight of the luggage, and an error value corresponding to the predicted weight of the luggage. For example, weight program 112B predicts that a luggage being transported by a passenger is 50 lbs. Weight program 112B generates a recommendation by transmitting a report to airline and security staff on a computer terminal, phone, or other mobile devices describing the passenger for identification by airline and security staff (e.g., a photograph of the passenger, name of the passenger, etc.), the luggage of the passenger for identification by airline and security staff (e.g., a photograph of the luggage), and the predicted weight of the luggage as 50 lbs., thus allowing the airline and security staff to act appropriately (e.g., either identify, stop, and question the passenger, or to further identify a storage location for the luggage to be stored on a transit vehicle). As described herein, the recommendation can a series of actions to be taken by the user and/or one or more notifications to be displayed on an electronic device. In some instances, the recommendation includes a confirmation of predicted weight and a recommended course of action in accordance with the predicted weight. For example, in instances where the predicted weight is within a weight limit specified by a transit authority, weight program 112B can confirm the predicted weight, inform the transit authority of the predicted weight, and complete a check-in process for the user (e.g., provide the user with an opportunity to pay for the checked-in bag, etc.)

In another embodiment, weight program 112B generates a recommendation based on the predicted weight of a load when the predicted weight of the load exceeds a threshold weight predetermined by transit staff. For example, weight program 112B predicts that a luggage being transported by a passenger is 100 lbs. Weight program 112B further predicts that the luggage exceeds a weight limit of 50 lbs. predetermined by transit staff. Weight program 112B generates a recommendation, based on the weight of the luggage exceeding the weight limit, by transmitting a report to airline and security staff on a computer terminal, phone, or other mobile devices describing the passenger for identification by airline and security staff (e.g., a photograph of the passenger, name of the passenger, etc.), the luggage of the passenger for identification by airline and security staff (e.g., a photograph of the luggage), and the predicted weight of the luggage as 100 lbs., thus allowing the airline and security staff to identify, stop, and question the passenger regarding the luggage of the passenger.

In a further embodiment, weight program 112B generates a recommendation based on the predicted weight of a luggage by transmitting a report to a transit device 110, wherein the report can also include a set of instructions for transit device 110 to allow a transit staff associated with transit device 110 to request a payment from the passenger when weight program 112B predicted the luggage associated with the passenger as overweight. In an even further embodiment, the report can also include a set of instructions for transit device 110 to generate one or more luggage tags for baggage check-in based on the quantity of baggage and the predicted weight of the bagged associated with the passenger. For example, a passenger carries a first and a second piece of luggage into a transit station. Weight program 112B predicts the weight of the first and second pieces of luggage, and predicts that the second piece of luggage is overweight. Weight program 112B generates a recommendation to transit device 110 informing a transit staff that the second piece of luggage is overweight, and requests a payment from the passenger regarding the overweight piece of luggage. Transit device 110 can have the capability to receive a credit or debit card payment from the passenger. Upon receiving a signal from transit device 110 signaling the payment as received from the passenger, weight program 112B generates a set of instructions to transit device 110 to print two baggage tags for the respective first and second pieces of luggage, wherein transit device 110 has a connected device that allows for the printing of baggage tags.

FIG. 3 is a flowchart 300 depicting operational steps of predicting a weight of a load associated with a passenger based on the analyzed recordings, in accordance with an embodiment of the present invention. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

In step 302, weight program 112A generates a profile associated with a passenger. In this embodiment, weight program 112A generates a profile for the passenger and stores the profile on database 114A. The profile includes, but is not limited to, a sex of the passenger, an age of the passenger, height, weight and current health status of the passenger. Weight program 112A receives inputs from the passenger that details the profile of the passenger. For example, weight program 112A generates a profile of a passenger upon collecting a recording of the passenger experiencing no loads and stores the profile on database 114A. Weight program 112A receives inputs from the passenger detailing the sex, age, height, weight, and current health status of the passenger and stores the inputs as part of the profile of the passenger.

In another embodiment, weight program 112B acquires the generated profile of the passenger by retrieving the profile of the passenger stored on database 114B. For example, weight program 112B uses facial recognition software to determine a passenger is associated with a profile of the passenger, and subsequently retrieves the profile of the passenger from database 114B.

In step 304, weight program 112B generates a statistical distribution of user-load interactions. In this embodiment, weight program 112B generates a statistical distribution of user-load interactions by collecting data points from a user, wherein the data points correlate direct measurements of a load, a value determined by a measurement technique, and a profile of the passenger. For example, in this embodiment, weight program 112B collects a recording of a passenger interacting with a load. Later, once the load has been received by the transit staff from the passenger, the transit staff can place the luggage on a physically interactive weighing scale (e.g., a digital spring scale) to obtain a direct measurement of the luggage, wherein the direct measurement includes, but is not limited to, a weight of the luggage. The direct measurement of the luggage can occur while the luggage is transported on a conveyer belt that sort luggage to the appropriate destination. Weight program 112B collects the direct measurement of the luggage from the physically interactive weighing scale, associates the direct measurement with the collected recording of the passenger interacting with the load, and stores the direct measurement and the associated recording in database 114B as a data point for the statistical distribution of user-load interactions for the corresponding profile of the passenger.

In a further embodiment, weight program 112B can collect additional data for the statistical distribution of user-load interactions, wherein the collected additional data allows for weight program 112B to use machine learning techniques in increasing the accuracy and precision of correlating the characteristics of a passenger to a weight of a load interacted by the passenger for the corresponding profile of the passenger. For example, in this embodiment, weight program 112B collects a recording of a passenger interacting with a load. Later, once the load has been received by the transit staff from the passenger, the transit staff can place the luggage on a physically interactive weighing scale (e.g., a digital spring scale) to obtain a direct measurement of the luggage, wherein the direct measurement includes, but is not limited to, a weight of the luggage. The direct measurement of the luggage can occur while the luggage is transported on a conveyer belt that sort luggage to the appropriate destination. Weight program 112B collects the direct measurement of the luggage from the physically interactive weighing scale, associates the direct measurement with the collected recording of the passenger interacting with the load, and stores the direct measurement and the associated recording in database 114B as additional data for the statistical distribution of user-load interactions for the corresponding profile of the passenger.

In another embodiment, weight program 112B can acquire a generated statistical distribution of user-load interactions by retrieving the statistical distribution of user-load interactions from database 114B based, at least in part, on the generated profile of the passenger and a measuring technique. For example, weight program 112B analyzed a recording of a passenger by using the Alexander technique as a measurement technique for the passenger who is 35 years of age, male, 6″ tall, weighing 160 lbs., and is in moderate health, and assigned a value of 8 to the recordings. Weight program 112B acquires the generated profile of the passenger such that the profile describes the passenger as being 35 years of age, male, 6″ tall, weighing 160 lbs., and is in moderate health. Weight program 112B then acquires a statistical distribution of user-load interactions corresponding to the Alexander technique as the measurement technique for a passenger being 35 years of age, male, 6″ tall, weighing 160 lbs., and is in moderate health from database 114B.

In step 306, weight program 112B matches the set of values to the acquired corresponding statistical distribution of user-load interactions. In this embodiment, weight program 112B matches the set of values to the acquired corresponding set of statistical distributions of user-load interactions by mapping the set of values corresponding to the recordings to the statistical distribution of user-load interactions. For example, weight program 112B analyzes a recording of a passenger interacting with a load using Alexander technique and Perry technique as two different measurement techniques. Weight program 112B determines values 8 and 10 corresponding to the Alexander technique and the Perry technique respectively. Weight program 112B identifies the passenger using facial recognition software, and acquires the profile of the passenger and the statistical distribution of user-load interactions corresponding to the Alexander technique and the Perry technique. Weight program 112B maps the value 8 determined by the Alexander technique to the statistical distribution of user-load interactions based on the Alexander technique and the profile of the passenger, and matches the value of 8 to a weight of 75 lbs Likewise, weight program 112B maps the value 10 determined by the Perry technique to the statistical distribution of user-load interactions based on the Perry technique and the profile of the passenger, and matches the value of 10 to a weight of 85 lbs.

In step 308, weight program 112B assigns a weight value for the load. In this embodiment, weight program 112B assigns a weight value to the load by averaging the matched set of weights. In continuing from the previous example, weight program 112B determined the matched values of the load are 75 lbs. corresponding to the Alexander technique measurement, and 85 lbs. corresponding to the Perry technique measurement. Weight program 112B averages the weights of 75 lbs. and 85 lbs. and assigns a weight value of 80 lbs. for the load.

In another embodiment, weight program 112B obtains an error value by taking the difference between the highest corresponded weight and the lowest corresponded weight, and dividing the difference by the average weight. An error value close to zero indicates a low error in the obtained final weight, whereas greater error values indicate a high error in the obtained final weight. In this embodiment, weight program 112B has an error threshold of 0.3, such that error values between 0-0.3 indicate that the obtained average weight is within acceptable error limits, whereas error values greater than 0.3 indicate that the obtained averaged weight is greater than the acceptable error limit. In continuing from the previous example using matched weight values of 75 lbs. and 85 lbs., weight program 112B obtains an error value of 0.13, indicating that the assigned weight for the load is within the acceptable error range.

In another embodiment, weight program 112B assigns a weight value for the load by using machine learning techniques of an artificial neural network. In this embodiment, weight program 112B continuously collects and stores recordings onto database 114B, wherein the recordings contain video recordings of a plurality of passengers of various characteristics and profiles while the plurality of passengers interact with various loads of known weights. In other words, weight program 112B builds a database of user-load interactions where characteristics of each passenger are corresponded to a known weight interacted by each passenger. As the number of collected recordings grow in database 114B, weight program 112B uses the increasing number of collected recordings to establish, and improve with increasing accuracy, a baseline measurement for a characteristic of a passenger. Based on the collected recordings, weight program 112B can compare a new recording of a passenger interacting with an unknown load to the database of user-load interactions to assign a weight to the load.

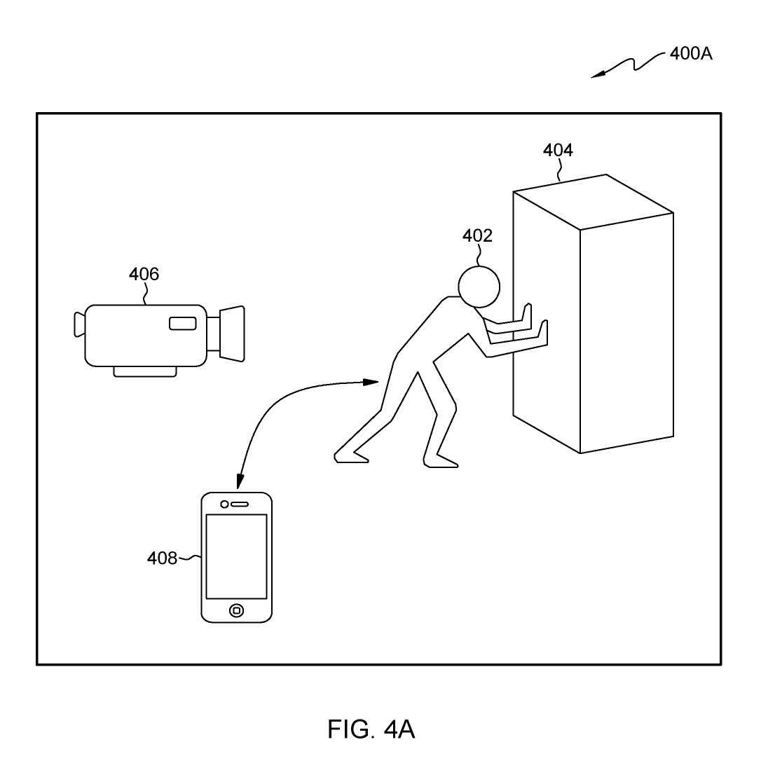

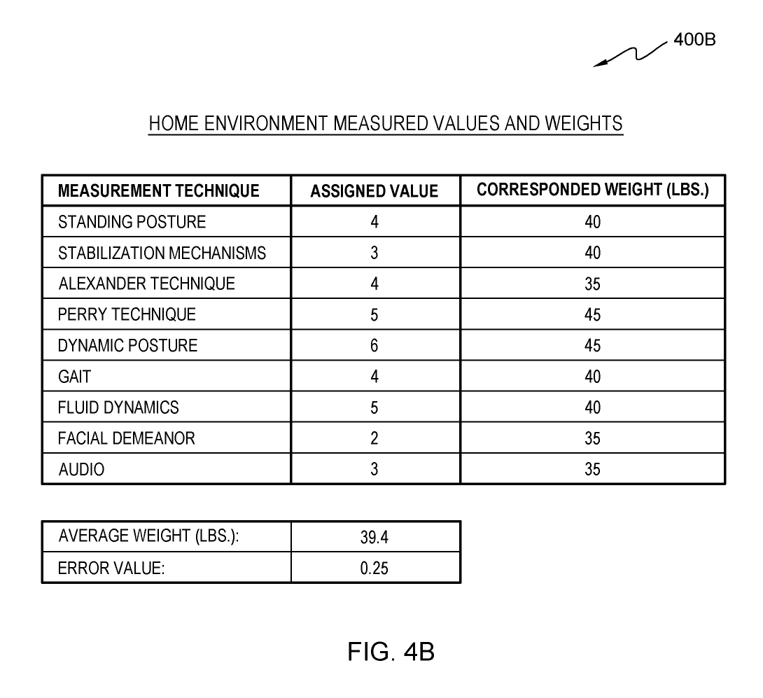

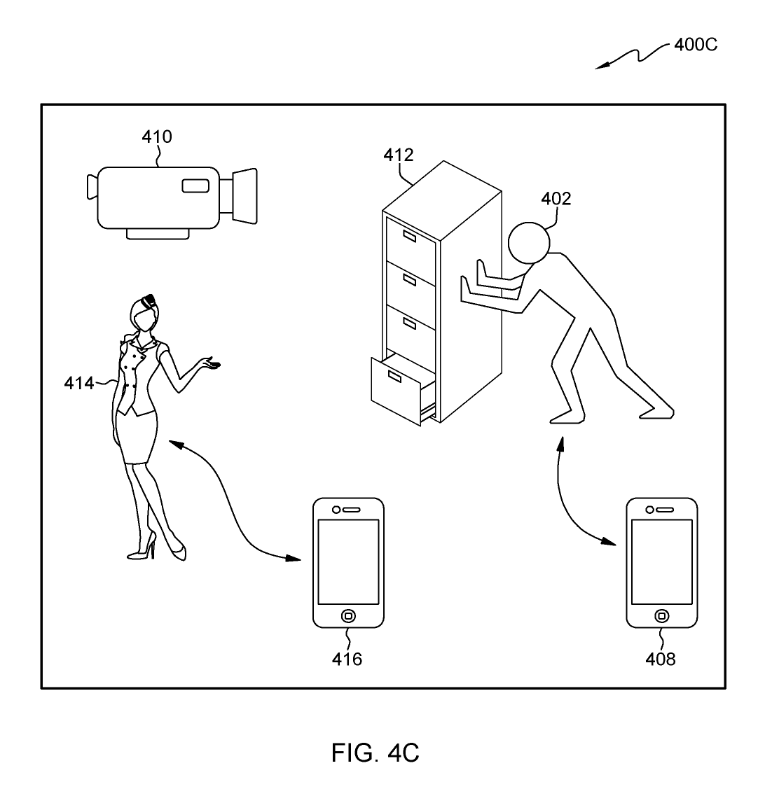

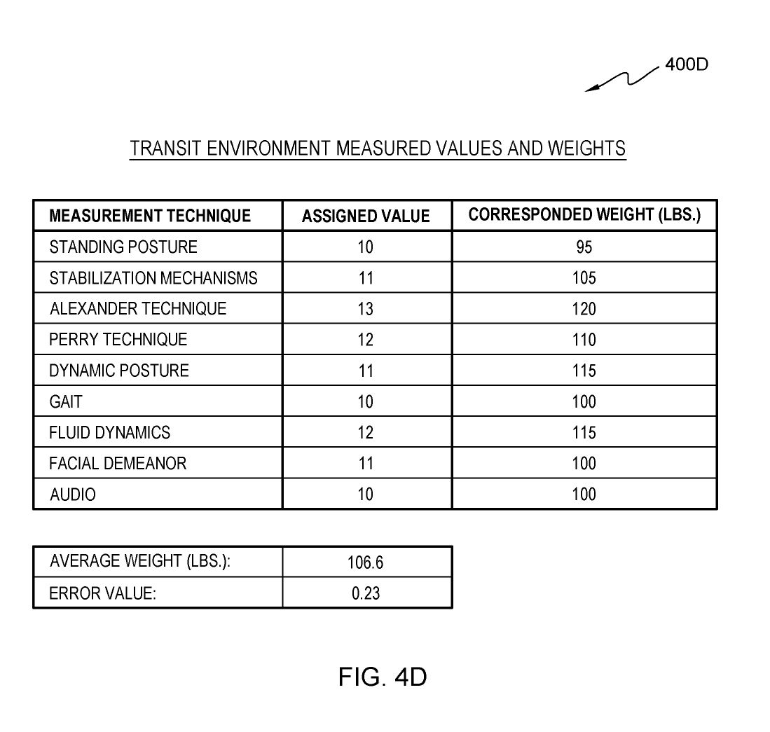

FIG. 4A is an example environment diagram illustrating a home environment for a weight program, in accordance with an embodiment of the present invention. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

FIG. 4A demonstrates an embodiment environment of a weight collection environment 400A, wherein weight program 112A operates on home smart camera 406 located in a home of passenger 402. In this example embodiment, passenger 402 pushes load 404 while being monitored by home smart camera 406. As used in this example embodiment, home smart camera 406 contains the co-functioning elements of home monitoring device 102A and home server computer 104A (further containing weight program 112A and database 114A). Mobile device 408 (containing database 114C) associated with passenger 402 operates within the functional network range of home smart camera 406 to allow data transfer of recordings collected by home smart camera 406. Furthermore, home smart camera 406 and mobile device 408 include internal and external hardware components capable of executing machine-readable program instructions, as depicted and described in further detail with respect to FIG. 5.

In this example embodiment, passenger 402 pushes load 404, and weight program 112A instructs home smart camera 406 to collect recordings of passenger 402 pushing load 404. Weight program 112A then instructs home smart camera 406 to upload recordings of passenger 402 onto mobile device 408. In this example, weight program 112A predicts the weight of the luggage as being within the parameters deemed acceptable by transit authorities. A more detailed example listing the techniques, measured values, and corresponding weight values for each factor used in the determination is described in greater detail with regard to FIG. 4B.

FIG. 4B provides table 400B listing the techniques, measured values, and corresponded weights for a recording of passenger 402 interacting with load 412 as described in the above example. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

Continuing the example discussed in FIG. 4A, weight program 112B analyzes the collected recording of passenger 402 interacting with load 404, and assigns the recording a set of values corresponding to a set of measurement techniques. In this example, weight program 112B assigns the following values for the listed measurement techniques to the recording: standing posture measurements—4; stabilization mechanisms—3; Alexander technique measurement—4; Perry technique measurement—5; dynamic posture measurement—6; gait measurement—4; fluid dynamic measurement—5; facial demeanor measurement—2; audio measurement—3. Weight program 112B acquires the profile of passenger 402 and a statistical distribution of user-load interactions for each measurement technique corresponding to the profile of passenger 402, and matches the value for each measurement technique to the corresponding statistical distribution to obtain a weight for load 404 for each measurement technique. In this example, weight program 112B matches values to corresponding weights for each of the following measurement techniques: standing posture measurements—4 (40 lbs.); stabilization mechanisms—3 (40 lbs.); Alexander technique measurement—4 (35 lbs.); Perry technique measurement—5 (45 lbs.); dynamic posture measurement—6 (45 lbs.); gait measurement—4 (40 lbs.); fluid dynamic measurement—5 (40 lbs.); facial demeanor measurement—2 (35 lbs.); audio measurement—3 (35 lbs.).

Weight program 112B then obtains a final weight for load 404 by averaging the corresponded weights. Continuing the example, weight program 112B obtains a final weight of 39.4 lbs. by averaging the corresponded weights. Weight program 112B obtains an error value of 0.25, indicating that the obtained final weight for load 404 is within the acceptable error range. FIG. 4B provides table 400B listing the techniques, measured values, and corresponded weights for a recording of passenger 402 interacting with load 404 as described in the above example.

FIG. 4C is an example environment diagram illustrating a transit environment for a weight program, in accordance with an embodiment of the present invention. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

FIG. 4C demonstrates an embodiment environment of a weight collection environment 400C, wherein weight program 112B operates on transit smart camera 410 located in a transit station entered by passenger 402 with load 412. In this example embodiment, passenger 402 enters a transit station pushing load 412 where load 412 has a different weight as load 404. Additionally, passenger 402 carries mobile device 408. As used in this example embodiment, transit smart camera 410 contains the co-functioning elements of transit monitoring device 102B and transit server computer 104B (further containing weight program 112B and database 114B). Mobile device 408 (containing database 114C, further storing recordings of passenger 402) associated with passenger 402 operates within the functional network range of transit smart camera 410 to allow data transfer of recordings stored on mobile device 408 onto transit smart camera 410. In this example embodiment, transit staff 414 assists in processing luggage at the transit station while monitoring transit device 416 for alerts or reports generated by transit smart camera 410. Furthermore, mobile device 408, transit smart camera 410, and transit device 416 include internal and external hardware components capable of executing machine-readable program instructions, as depicted and described in further detail with respect to FIG. 5. In this example embodiment, passenger 402 enters a transit station pushing load 412 while carrying mobile device 408. Weight program 112B detects mobile device 408 has entered the functional network range of transit smart camera 410, and instructs transit smart camera 410 to collect recordings of passenger 402 stored on mobile device 408. Furthermore, weight program 112B instructs transit smart camera 410 to collect recordings of passenger 402 pushing load 412.

Continuing the example discussed in FIG. 4C, weight program 112B then analyzes the collected recording of passenger 402 interacting with load 412. In this example, weight program 112B assigns the following values for the listed techniques for the recording of passenger 402 interacting with load 412: standing posture measurements—10; stabilization mechanisms—11; Alexander technique measurement—13; Perry technique measurement—12; dynamic posture measurement—11; gait measurement—10; fluid dynamic measurement—12; facial demeanor measurement—11; audio measurement—10. Weight program 112B then matches the value for each measurement technique to the corresponding statistical distribution to obtain a weight for load 404 for each measurement technique. In this example, weight program 112B matches values to corresponding weights for each of the following measurement techniques: standing posture measurements—10 (95 lbs.); stabilization mechanisms—11 (105 lbs.); Alexander technique measurement—13 (120 lbs.); Perry technique measurement—12 (110 lbs.); dynamic posture measurement—11 (115 lbs.); gait measurement—10 (100 lbs.); fluid dynamic measurement—12 (115 lbs.); facial demeanor measurement—11 (100 lbs.); audio measurement—10 (100 lbs.). Weight program 112B averages the matched weights to obtain a final weight of 106.6 lbs. with an error value of 0.23.

FIG. 4D provides table 400D listing the techniques, measured values, and corresponded weights for a recording of passenger 402 interacting with load 412 as described in the above example. In the exemplary embodiments listed below, a first user is referred to as a “passenger”, and a second user is referred to as a “transit staff”; however, it should be understood that a user can be a person or device utilizing weight program 112, and not limited to just a passenger or transit staff.

In continuing the example, weight program 112B further predicts that load 412 is overweight based upon an 80 lbs. weight limit set by the transit station. Weight program 112B generates a report to transit device 416 to alert transit staff 414 that passenger 402 is transporting an overweight load by identifying passenger 402 and load 412, and the providing the weight 106.6 lbs. corresponding to load 412, and an error value of 0.23. Transit staff 414 receives the report, and subsequently alerts passenger 402 that load 412 is overweight.

In alternate embodiment, if weight program 112B obtains a weight of 50 lbs. with an error value of 0.5, then weight program 112B generates a report to transit device 416 to alert transit staff 414 that passenger 402 is transporting a load of an uncertain weight. Transit staff 414 receives the report, and alerts passenger 402 that load 412 needs to be measured directly due to the uncertain weight of load 412.

FIG. 5 depicts a block diagram of components of computing systems within weight collection environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Weight program 112 may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Weight program 112 may be downloaded to persistent storage 508 through communications unit 510.

I/O interface(s) 512 allows for input and output of data with other devices that may be connected to server computer 102. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., weight program 112, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
analyzing recordings of a user interacting with a load based on a baseline measurement and a set of measurement techniques;
predicting a weight of the load based on the analyzed recordings of the user interacting with the load; and
generating a recommendation that includes a series of actions and notifications to be displayed on a user interface based on the predicted weight.

2. The computer-implemented method of claim 1, wherein predicting the weight of the load based on the analyzed recordings of the user interacting with the load comprises:
generating a profile of the user;
generating a set of statistical distributions of user-load interactions corresponding to the set of measurement techniques;
matching a set of values to the generated set of statistical distributions of the user-load interactions, wherein the set of values are used to predict a weight and are based on the set of measurement techniques corresponding to the analyzed recordings; and
assigning a weight to the load based on the matched set of values.

3. The computer-implemented method of claim 1, further comprising:
recording the user interacting with one or more loads, wherein the recordings are continuously uploaded to a database of a transit server computer.

4. The computer-implemented method of claim 3, wherein recording the user interacting with one or more loads comprises:
continuously recording the user interacting with the one or more loads and storing the recording to a database corresponding to a home server computer;
continuously uploading the recordings of the database of the home server computer with a database of a mobile device corresponding to the user; and
downloading the continuously uploaded database of the mobile device corresponding to the user to a database of a transit server computer.

5. The computer-implemented method of claim 1, wherein the baseline measurement and the set of measurement techniques are based on a characteristic of a user, wherein the characteristic of a user includes posture, facial demeanor, and audible sounds produced by the user.

6. The computer-implemented method of claim 1, wherein the baseline measurement and the set of measurement techniques are based on a characteristic of a load, wherein the characteristic of a load includes material composition of the load, and a volume of the load.

7. The computer-implemented method of claim 1, wherein the generated recommendation is created for display on a user device, wherein the display of the generated recommendation includes an interface that specifies a screen for user identification, load identification, the predicted weight of a load corresponding to the user, and an error value corresponding to the determined weight of the load.

8. A computer program product comprising:
one or more computer readable storage media and program instructions stored on the one or more computer readable storage media, the program instructions comprising:
program instructions to analyze recordings of a user interacting with a load based on a baseline measurement and a set of measurement techniques;
program instructions to predict a weight of the load based on the analyzed recordings of the user interacting with the load; and
program instructions to generate a recommendation that includes a series of actions and notifications to be displayed on a user interface based on the predicted weight.

9. The computer program product of claim 8, wherein the program instructions to predict the weight of the load based on the analyzed recordings of the user interacting with the load comprise:
program instructions to generate a profile of the user;
program instructions to generate a set of statistical distributions of user-load interactions corresponding to the set of measurement techniques;
program instructions to match a set of values to the generated set of statistical distributions of the user-load interactions, wherein the set of values are used to predict a weight and are based on the set of measurement techniques corresponding to the analyzed recordings; and
program instructions to assign a weight to the load based on the matched set of values.

10. The computer program product of claim 8, further comprising:
program instructions to record the user interacting with one or more loads, wherein the recordings are continuously uploaded to a database of a transit server computer.

11. The computer program product of claim 10, wherein the program instructions to record the user interacting with one or more loads comprise:
program instructions to continuously record the user interacting with the one or more loads and storing the recording to a database corresponding to a home server computer;
program instructions to continuously upload the recordings of the database of the home server computer with a database of a mobile device corresponding to the user; and
program instructions to download the continuously uploaded database of the mobile device corresponding to the user to a database of a transit server computer.

12. The computer program product of claim 8, wherein the baseline measurement and the set of measurement techniques are based on a characteristic of a user, wherein the characteristic of a user includes posture, facial demeanor, and audible sounds produced by the user.

13. The computer program product of claim 8, wherein the baseline measurement and the set of measurement techniques are based on a characteristic of a load, wherein the characteristic of a load includes material composition of the load, and a volume of the load.

14. The computer program product of claim 8, wherein the generated recommendation is created for display on a user device, wherein the display of the generated recommendation includes an interface that specifies a screen for user identification, load identification, the predicted weight of a load corresponding to the user, and an error value corresponding to the determined weight of the load.

15. A computer system comprising:
one or more computer processors;
one or more computer readable storage media; and
program instructions stored on the one or more computer readable storage media for execution by at least one of the one or more processors, the program instructions comprising:
program instructions to analyze recordings of a user interacting with a load based on a baseline measurement and a set of measurement techniques;
program instructions to predict a weight of the load based on the analyzed recordings of the user interacting with the load; and
program instructions to generate a recommendation that includes a series of actions and notifications to be displayed on a user interface based on the predicted weight.

16. The computer system of claim 15, wherein the program instructions to predict the weight of the load based on the analyzed recordings of the user interacting with the load comprise:
program instructions to generate a profile of the user;
program instructions to generate a set of statistical distributions of user-load interactions corresponding to the set of measurement techniques;
program instructions to match a set of values to the generated set of statistical distributions of the user-load interactions, wherein the set of values are used to predict a weight and are based on the set of measurement techniques corresponding to the analyzed recordings; and
program instructions to assign a weight to the load based on the matched set of values.

17. The computer system of claim 15, further comprising:
program instructions to record the user interacting with one or more loads, wherein the recordings are continuously uploaded to a database of a transit server computer.

18. The computer system of claim 17, wherein the program instructions to record the user interacting with one or more loads comprise:
program instructions to continuously record the user interacting with the one or more loads and storing the recording to a database corresponding to a home server computer;
program instructions to continuously upload the recordings of the database of the home server computer with a database of a mobile device corresponding to the user; and
program instructions to download the continuously uploaded database of the mobile device corresponding to the user to a database of a transit server computer.

19. The computer system of claim 15, wherein the baseline measurement and the set of measurement techniques are based on a characteristic of a user, wherein the characteristic of a user includes posture, facial demeanor, and audible sounds produced by the user.

20. The computer system of claim 15, wherein the generated recommendation is created for display on a user device, wherein the display of the generated recommendation includes an interface that specifies a screen for user identification, load identification, the predicted weight of a load corresponding to the user, and an error value corresponding to the determined weight of the load.
